(19) United States
(12) Patent Application Publication
(10) Pub. No.: US 2024/0174171 A1
(43) Pub. Date: May 30, 2024

(54) CONTROL DEVICE FOR VEHICULAR ILLUMINATION

(71) Applicants: TOYOTA JIDOSHA KABUSHIKI KAISHA, Toyota-shi (JP); Sumitomo Wiring Systems, Lid., Yokkaichi Mie (JP)

(72) Inventors: Yasunori WAKAMATSU, Nagakute-shi (JP); Masatoshi ISHINO, Nagakute-shi (JP); Yuuki ARAI, Toyota-shi (JP); Akihiro KUSADA, Yokkaichi-shi (JP)

(73) Assignees: TOYOTA JIDOSHA KABUSHIKI KAISHA, Toyota-shi (JP); Sumitomo Wiring Systems, Lid., Yokkaich-Mie (JP)

(21) Appl. No.: 18/512,799

(22) Filed: Nov. 17, 2023

(30) Foreign Application Priority Data
Nov. 25, 2022 (JP) 2022-187952

(51) Int. Cl. B60Q 3/80

(52) U.S. Cl. CPC B60Q 3/80

(57) ABSTRACT

A control device for a vehicular illumination is configured to make definition of factors of an illumination control operation with a higher priority unnecessary when definition of factors of the illumination control operation with the higher priority is the same as definition of factors of an illumination control operation with a lower priority than the illumination control operation with a higher priority.

### CROSS-REFERENCE TO RELATED APPLICATION

This application claims priority to Japanese Patent Application No. 2022-187952 filed on Nov. 25, 2022, incorporated herein by reference in its entirety.

### BACKGROUND

### 1. Technical Field

The disclosure relates to a control device for a vehicular illumination.

### 2. Description of Related Art

Japanese Unexamined Patent Application Publication No. 2002-192983 (JP 2002-192983 A) discloses a control device for a vehicular illumination that turns on an illumination installed in a cabin of a vehicle according to vehicle information and occupant information.

In general, vehicles perform the following control operations associated with an illumination:
(a) an operation of controlling an illumination according to scenes (such as entry/exit and travel) (for example, gradually turning on the illumination to 100% to secure visibility at the time of entry);
(b) an operation of allowing a user to adjust luminance; and
(c) an operation of adjusting luminance by determining day and night.

In illumination control according to the related art, three factors (color, luminance, and time) are defined for each of (a)×(b)×(c) variations. When a new illumination control operation is added, three factors (color, luminance, and time) are defined for each of the variations. This is because illumination control has a control structure in which operations (outputs) of the illumination have to be defined in one-to-one correspondence. Accordingly, when a new illumination control operation is added, definition items for color, luminance, and time become massive, which causes a decrease in development speed, an increase in the number of development steps, concern about quality due to mistake, and an additional increase in the number of steps for preventing mistakes.

### SUMMARY

The disclosure provides a control device for a vehicular illumination that can reduce an amount of definition of a newly added illumination control operation.

The disclosure employs the following configurations:
(1) A control device for a vehicular illumination, wherein the control device is configured to determine priorities of a plurality of illumination control operations for decorating the same place and to make definition of factors of an illumination control operation with a higher priority unnecessary when definition of factors of the illumination control operation with the higher priority is the same as definition of factors in an illumination control operation with a lower priority than the illumination control operation with the higher priority; and
(2) The control device for a vehicular illumination according to (1), wherein the definition of factors in the illumination control operation with the next higher priority is used as the definition of factors in the illumination control operation with the higher priority that has been made unnecessary.

With the control device for a vehicular illumination according to (1), since the priorities of a plurality of illumination control operations for decorating the same place are determined and definition of factors in an illumination control operation with a higher priority is made unnecessary when definition of factors in the illumination control operation with the higher priority is the same as definition of factors in an illumination control operation with a lower priority than the illumination control operation with the higher priority, it is not necessary to define all factors in the illumination control operation with the higher priority. Accordingly, when a new illumination control operation is added, the same definition of factors as definition of factors in an illumination control operation with a next higher priority becomes unnecessary, and thus it is possible to reduce an amount of definition of factors in the newly added illumination control operation.

With the control device for a vehicular illumination according to (2), since the definition of factors in the illumination control operation with the next higher priority is used as the definition of factors in the illumination control operation with the higher priority that has been made unnecessary, it is possible to perform the illumination control operation with the higher priority according to the definition of factors in the illumination control operation with the next higher priority even when definition of factors in the illumination control operation with the higher priority is unnecessary. Accordingly, it is possible to perform a newly added illumination control operation even when definition of factors in the newly added illumination control operation is unnecessary.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a system configuration of a control device for a vehicular illumination according to an embodiment of the disclosure;

FIG. 2 is a matrix table illustrating (scenes)×(adjustment of luminance by user)×(adjustment of luminance based on determination of night and day) variations in which three factors of color, luminance, and time are defined in the control device for a vehicular illumination according to the embodiment of the disclosure;

FIG. 3 is a diagram illustrating an example of change from a scene illumination control operation to a newly added ZZZ illumination control operation in the control device for a vehicular illumination according to the embodiment of the disclosure; and

FIG. 4 is a diagram illustrating a system configuration in a comparative example (which is not an embodiment of the disclosure) of the control device for a vehicular illumination according to the embodiment of the disclosure.

### DETAILED DESCRIPTION OF EMBODIMENTS

Hereinafter, a control device for a vehicular illumination (hereinafter also simply referred to as a control device) 10 according to an embodiment of the disclosure will be described with reference to the accompanying drawings.

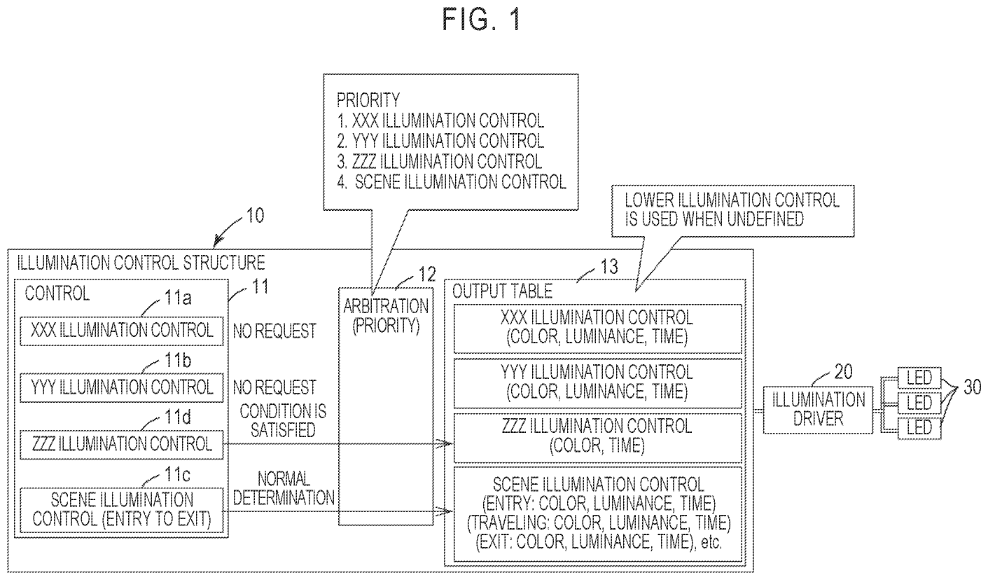

The control device 10 according to an embodiment of the disclosure is a device that controls an illumination of a vehicle. The control device 10 is configured to perform a plurality of control operations for decorating the same place of the vehicle. Accordingly, the priority order (priorities) is determined for the plurality of control operations for decorating the same place, and a control operation with a higher priority is output and performed when conditions for both a control operation with a higher priority and a control operation with a next higher priority are satisfied. For this purpose, the control device 10 includes a control unit 11, an arbitration unit 12, and an output unit (an output table) 13 as illustrated in FIG. 1.

The control device 10 is configured to perform a plurality of control operations for decorating the same place as described above. In the following embodiment of the disclosure, it is assumed that the plurality of control operations for decorating the same place include an XXX illumination control operation 11a, a YYY illumination control operation 11b, and a scene illumination control operation 11c.

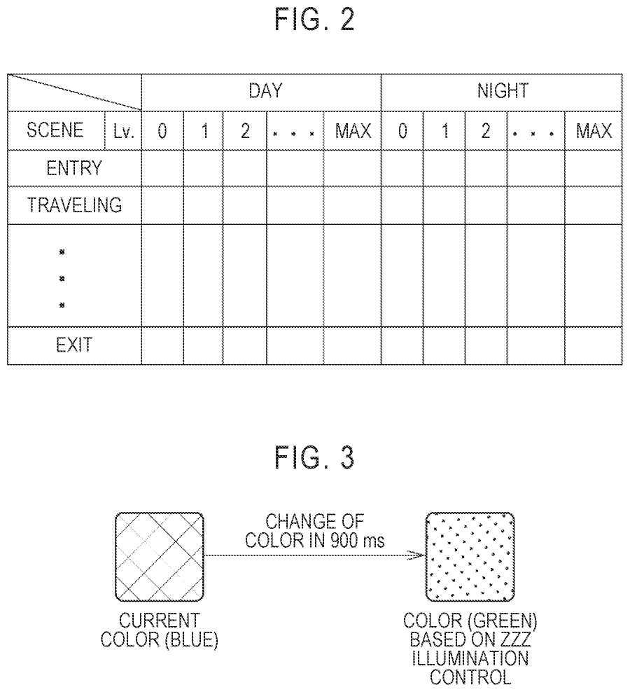

As illustrated in FIG. 2, similarly to the related art, each of the XXX illumination control operation 11a, the YYY illumination control operation 11b, and the scene illumination control operation 11c includes (a) an operation of controlling an illumination according to scenes (such as entry/exit and travel), (b) an operation of allowing a user to adjust luminance, and (c) an operation of adjusting luminance by determining day and night. Three factors (color, luminance, and time) are defined for each of (a)×(b)×(c) variations. FIG. 2 illustrates a matrix indicating the (a) to (c) variations, where scenes for (a) are shown in a column, Lv. for (b) is shown in the second row, and night and day for (c) are shown in the first row. Three factors (color, luminance, and time) are defined for each mass.

In the control unit 11, three factors (color, luminance, and time) defined for each of the XXX illumination control operation 11a, the YYY illumination control operation 11b, and the scene illumination control operation 11c are stored for each mass illustrated in FIG. 2.

As illustrated in FIG. 1, the arbitration unit 12 determines priorities of the XXX illumination control operation 11a, the YYY illumination control operation 11b, and the scene illumination control operation 11c. In FIG. 1, an example in which the priorities of the XXX illumination control operation 11a, the YYY illumination control operation 11b, and the scene illumination control operation 11c decrease in that order is illustrated.

When conditions for the XXX illumination control operation 11a and the YYY illumination control operation 11b out of the XXX illumination control operation 11a, the YYY illumination control operation 11b, and the scene illumination control operation 11c are not satisfied and thus illumination control thereof is not requested and a condition for only the scene illumination control operation 11c is satisfied, a signal for the scene illumination control operation 11c is sent from an output unit 13 to an illumination driver 20 driving an LED (light emitting unit) 30 for the illumination to be turned on, and the LED 30 emits light in response to the signal.

Here, it is assumed that a new ZZZ illumination control operation 11d is added to decorate the same place in addition to the XXX illumination control operation 11a, the YYY illumination control operation 11b, and the scene illumination control operation 11c. The ZZZ illumination control operation 11d is a new control operation which is added to decorate the same place as the XXX illumination control operation 11a, the YYY illumination control operation 11b, and the scene illumination control operation 11c. In this case, it is assumed that the priority of the ZZZ illumination control operation 11d is lower than that of the YYY illumination control operation 11b and higher than that of the scene illumination control operation 11c.

In the related art, three factors (color, luminance, and time) of the ZZZ illumination control operation 11d need to be defined for each of the (a)×(b)×(c) variations. However, this excessively increases an amount of definition. Therefore, in the embodiment of the disclosure, when the ZZZ illumination control operation 11d has the same definition as the definition of factors of the scene illumination control operation 11c with a priority lower than that of the ZZZ illumination control operation 11d, the definition of factors of the scene illumination control operation 11c is used without defining the factors in the ZZZ illumination control operation 11d.

For example, when color and time out of three factors including color, luminance, and time of the ZZZ illumination control operation 11d are changed and luminance is the same as in the scene illumination control operation 11c (current luminance is kept), the definition of luminance of the scene illumination control operation 11c with a next higher priority is used without newly defining luminance of the ZZZ illumination control operation 11d.

Since the definition of factors of the scene illumination control operation 11c with a next higher priority is used as definition of factors of a control operation with a higher priority, the scene illumination control operation 11c has a lowest priority, but is normally performed up to the output unit 13. When the condition of the XXX illumination control operation 11a, the YYY illumination control operation 11b, or the ZZZ illumination control operation 11d with higher priorities than the scene illumination control operation 11c is not satisfied, a signal of the scene illumination control operation 11c is output from the output unit 13 to the illumination driver 20 without any change. In this state, when the condition of the XXX illumination control operation 11a, the YYY illumination control operation 11b, or the ZZZ illumination control operation 11d with higher priorities than the scene illumination control operation 11c is satisfied, a signal of the XXX illumination control operation 11a, the YYY illumination control operation 11b, or the ZZZ illumination control operation 11d instead of the signal of the scene illumination control operation 11c is output from the output unit 13 to the illumination driver 20 according to the priorities.

For example, when the conditions of the XXX illumination control operation 11a and the YYY illumination control operation 11b are not satisfied and the condition of the ZZZ illumination control operation 11d is satisfied in a state in which the condition of the scene illumination control operation 11c is satisfied while the vehicle is traveling, the ZZZ illumination control operation 11d has a priority higher than that of the scene illumination control operation 11c, but luminance of the ZZZ illumination control operation 11d is not defined at that time and thus luminance while traveling of the scene illumination control operation 11c is used.

FIG. 3 is a diagram illustrating an example of change from the scene illumination control operation 11c to the ZZZ illumination control operation 11d. In FIG. 3, it is assumed that change from the scene illumination control operation 11c to the ZZZ illumination control operation 11d is performed under the following conditions.
A condition that color and time of three factors of the newly added ZZZ illumination control operation 11d are defined, luminance thereof is not defined, and luminance of the scene illumination control operation 11e is used.
A condition that the condition of only the scene illumination control operation 11c is satisfied while traveling or the like, and the condition of the ZZZ illumination control operation 11d is satisfied.
A condition that color of the scene illumination control operation 11e is blue, color of the ZZZ illumination control operation 11d is green, and the color changes in 900 ms.

As illustrated in FIG. 3, even when only color and time of the newly added ZZZ illumination control operation 11d are defined and luminance is not defined, it is possible to perform the ZZZ illumination control operation 11d by using luminance of the scene illumination control operation 11c with a next higher priority.

Operations and advantages of the embodiment of the disclosure will be described below.

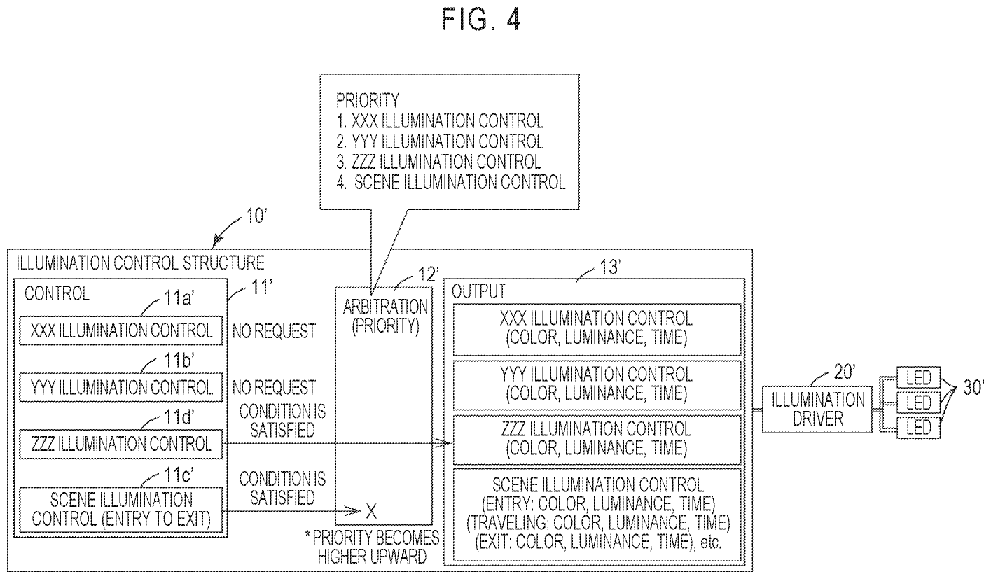

FIG. 4 is a diagram illustrating a control device 10′ according to a comparative example (which is not an embodiment of the disclosure) of the embodiment of the disclosure. In FIG. 4, similarly to the embodiment of the disclosure, it is assumed that a ZZZ illumination control operation 11d is newly added to decorate the same place in addition to the XXX illumination control operation 11a, the YYY illumination control operation 11b, and the scene illumination control operation 11c. For the purpose of distinction from the embodiment of the disclosure, the elements in the comparative example illustrated in FIG. 4 corresponding to those in the embodiment of the disclosure will be referred to by adding “′” (prime) to the same reference signs as in the embodiment of the disclosure.

In the comparative example, all the three factors (color, luminance, and time) of the ZZZ illumination control operation 11d′ are defined for each of the (a)×(b)×(c) variations regardless of control of the scene illumination control operation 11c′ with a next higher priority. That is, illumination operations (outputs) for the illumination control operations are defined in a one-to-one correspondence manner.

Accordingly, in the control device 10′ illustrated in FIG. 4, when the condition of the ZZZ illumination control operation 11d′ is satisfied in a state in which the condition of only the scene illumination control operation 11c′ is satisfied, the ZZZ illumination control operation 11d′ is output instead of the scene illumination control operation 11c′ according to the priorities.

In the control device 10′ illustrated in FIG. 4, since all the three factors (color, luminance, and time) of an illumination control operation (the ZZZ illumination control operation 11d′) which is newly added are defined for each of the (a)×(b)×(c) variations regardless of an illumination control operation with a next higher priority (the scene illumination control operation 11c′), an amount of definition for the newly added illumination control operation with a higher priority (the ZZZ illumination control operation 11d′) becomes larger.

However, in the embodiment of the disclosure, when definition of factors of the illumination control operation with a higher priority is the same as the definition of factors of the illumination control operation with a next higher priority, definition of the factors of the illumination control operation with a higher priority is not necessary and thus it is not necessary to define all the factors of the illumination control operation with a higher priority. Accordingly, when a new illumination control operation is added, definition of the same factors as factors of the illumination control operation with a next higher priority is unnecessary and thus it is possible to reduce an amount of definition of the factors of the newly added illumination control operation.

Since definition of factors of an illumination control operation with a next higher priority is used as definition of factors of an illumination control operation with a higher priority considered to be unnecessary, it is possible to perform the illumination control operation with a higher priority based on the definition of factors of the illumination control operation with a next higher priority even when definition of factors of the illumination control operation with a higher priority is unnecessary. Accordingly, it is possible to perform a newly added illumination control operation even when definition of factors of the newly added illumination control operation is unnecessary.

What is claimed is:

1. A control device for a vehicular illumination, wherein the control device is configured to determine priorities of a plurality of illumination control operations for decorating the same place and to make definition of factors of an illumination control operation with a higher priority unnecessary when definition of factors of the illumination control operation with the higher priority is the same as definition of factors in an illumination control operation with a lower priority than the illumination control operation with the higher priority.
